(19) United States
(12) Patent Application Publication
(10) Pub. No.: US 2019/0093804 A1
(43) Pub. Date: Mar. 28, 2019

(54) MALE SWIVEL HOSE COUPLING

(71) Applicant: WINZELER STAMPING COMPANY, Montpelier, OH (US)

(72) Inventor: Michael E. Allman, Montpelier, OH (US)

(21) Appl. No.: 16/145,359

(22) Filed: Sep. 28, 2018

Related U.S. Application Data
(60) Provisional application No. 62/564,672, filed on Sep. 28, 2017.

(51) Int. Cl. F16L 27/10

(52) U.S. Cl. CPC F16L 27/1008; F16L 27/1017

(57) ABSTRACT

A male swivel hose coupling includes a hollow tail piece having a receiving portion and a stem and a hollow collar having a threaded portion. The collar is received over the receiving portion and is freely rotatable with respect to the receiving portion. The receiving portion of the tailpiece includes a rim and a shoulder, and the collar includes a lip and a shoulder. The rim of the receiving portion forms a first stopping surface for engaging the lip and the shoulder of the receiving portion forms a second stopping surface for engaging the shoulder of the collar.

### CROSS REFERENCE TO RELATED APPLICATIONS

This patent application claims priority to U.S. Provisional Patent Application Ser. No. 62/564,672, filed on Sep. 28, 2017, the entire disclosure of which is hereby incorporated herein by reference.

### FIELD OF THE INVENTION

The present invention relates to a coupling for a hose, and more particularly, to a male swivel hose coupling having a freely rotating collar with male threading.

### BACKGROUND OF THE INVENTION

As is commonly known, hoses such as gardening hoses typically include a coupling at each end of the hose. One end of the hose typically includes a female coupling having recessed threads to couple with a complementary male threaded water source or male threaded coupling of another hose. The opposing end of the hose typically includes a male coupling having threads on an outer surface thereof to accept and couple with a female threaded accessory such as a nozzle, spray gun, sprinkler, pressure washer, wand, a similar device, or a female threaded coupling of another hose.

It is quite common for the use of a hose to include transporting the accessory end of the hose to various different locations for performing various tasks. However, it is common for movement of such hoses to be undesirably cumbersome as the movement of such hoses may also require an undesired amount of effort to pull and/or drag the hose from one location to another. Additionally, during movement of the hose, kinks, twists, bends, and the like can form in the hose due to the manner in which the hose is statically fixed to the water source and unable to rotate relative thereto. This condition can be problematic when a certain water pressure is desired for the given task, as the kinks formed in the hose tend to minimize the flow rate and the pressure of the water flowing therethrough.

Accordingly, it would be desirable to produce a coupling for a hose having a swiveling feature that minimizes kinks in the hose while maximizing transportability of the hose.

### SUMMARY OF THE INVENTION

In accordance and attuned with the present invention, a coupling for minimizing kinks in the hose and maximizing transportability of the hose has surprisingly been discovered.

According to an embodiment of the disclosure, a coupling is disclosed. The coupling includes a hollow tail piece having a receiving portion. The coupling further includes a hollow collar having a threaded portion, wherein the collar is received over the receiving portion. The collar is freely rotatable with respect to the receiving portion.

According to another embodiment of the disclosure, a hose assembly is disclosed. The hose assembly comprises a hose and a coupling. The coupling comprises a hollow collar having a threaded portion and a hollow tailpiece having a receiving portion and a stem. The stem is received in the hose. The collar is received over the receiving portion and is freely rotatable with respect to the receiving portion.

### BRIEF DESCRIPTION OF THE DRAWINGS

The above advantages of the invention will become readily apparent to those skilled in the art from reading the following detailed description of an embodiment of the invention in the light of the accompanying drawings, in which:

FIG. 1 is fragmentary top plan view of a hose having a male swivel hose coupling according to an embodiment of the disclosure;

FIG. 2 is a cross-sectional elevational view of a tailpiece and a collar cooperating to form a portion of the male swivel hose coupling of FIG. 1;

FIG. 3 is a cross-sectional elevational view of the tailpiece and collar of FIG. 2 following a deformation of a portion of the tailpiece to secure the collar to the tailpiece;

FIG. 4 is a cross-sectional elevational view showing a hose and ferrule for completing assembly of the male swivel hose coupling; and

FIG. 5 is an enlarged fragmentary cross-sectional view of a portion of the male swivel hose coupling surrounded by circle 5 of FIG. 3.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

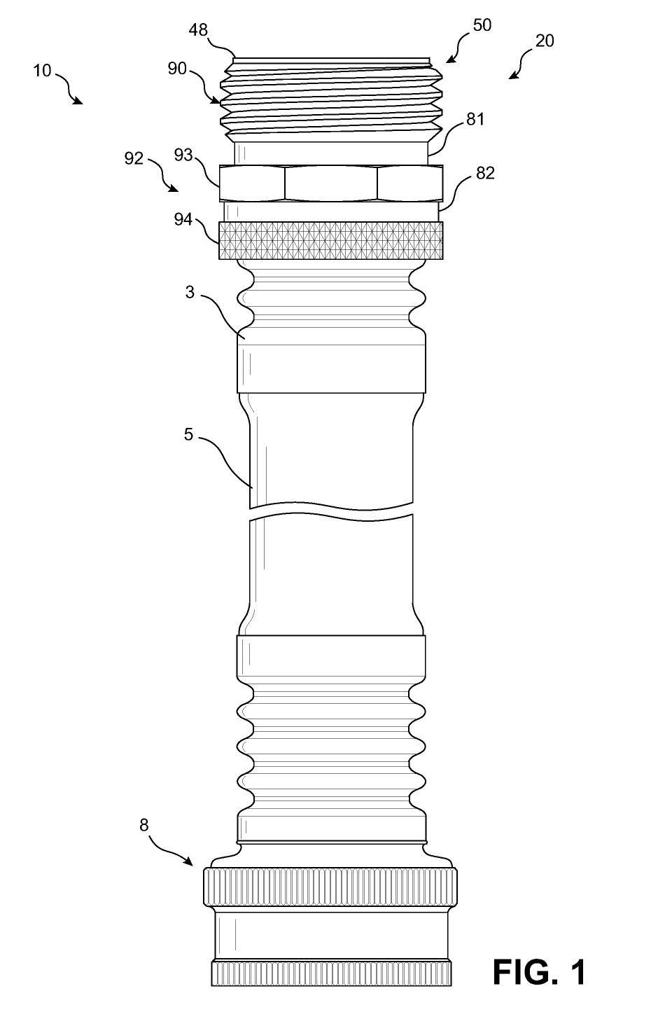

FIG. 1 illustrates a hose assembly 10 having a male swivel hose coupling 20, referred to as the male coupling 20 hereinafter, according to an embodiment of the present invention. The hose assembly 10 may further include a length of hose 5 having the male coupling 20 disposed at a first end thereof and a secondary coupling 8 disposed at an opposing second end thereof. The secondary coupling 8 may be a female coupling including an internally threaded circumferential surface suitable for mating with a corresponding male coupling such as the male coupling 20 or a male coupling typically present at an outlet of a water source such as a traditional outdoor water faucet or spigot. The male coupling 20 may be configured for coupling to a corresponding female coupling associated with another length of hose for extending an overall length or reach of the hose or the male coupling 20 may be coupled to an end accessory such as a sprinkler, wand, nozzle, or the like, as non-limiting examples.

The male coupling 20 includes a swivel feature for allowing a male threaded portion 90 of the male coupling 20 to rotate relative to the first end of the hose 5. This relative rotation allows for the extension hose or the end accessory coupled to the male coupling 20 to be freely rotated relative to the length of the hose 5, thereby preventing an incidence of kinks forming in the hose 5 during a transporting of the hose 5 from one location to another or during use of the hose 5.

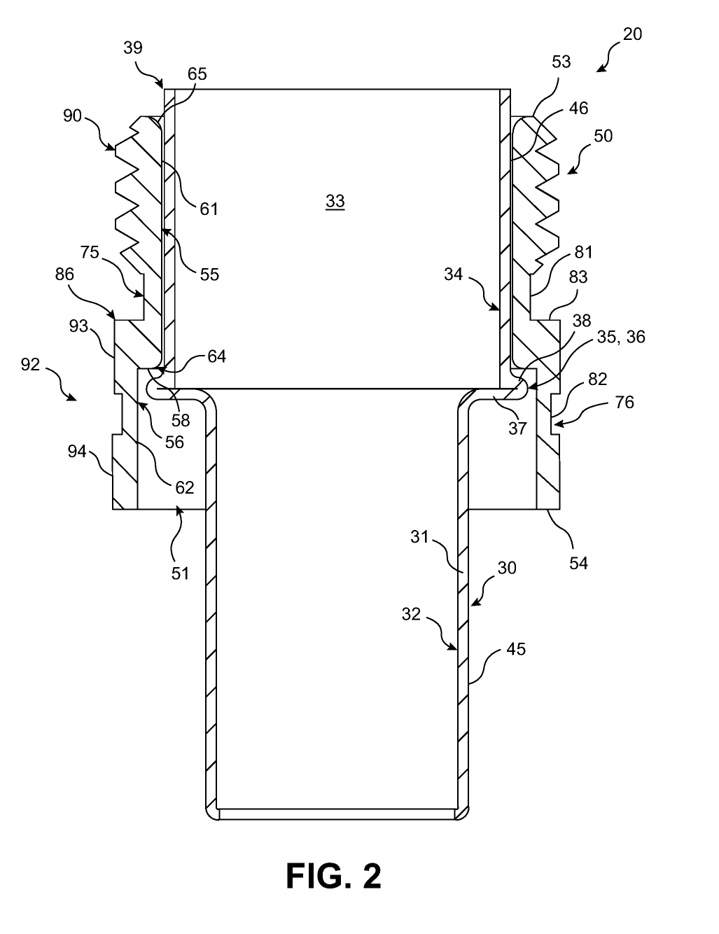

As shown in FIGS. 2-4, the male coupling 20 includes a hollow tailpiece 30 and a hollow collar 50 freely rotatable relative to the tailpiece 30. A structure of the male coupling 20 may be best understood by description of a method of assembling the male coupling 20, as explained hereinafter with specific reference to FIGS. 2-5 of the present patent application.

As illustrated in FIG. 2, the tailpiece 30 includes a stem 32 and a receiving portion 34. The stem 32 is configured for insertion into the first end of the hose 5 and the receiving portion 34 is configured for receiving the collar 50 of the male coupling 20 thereover. The stem 32 and the receiving portion 34 may be formed integrally from a common structure, as shown in FIG. 2. The stem 32 can alternatively be separately formed from and subsequently coupled to the receiving portion 34 without departing from the scope of the present invention, as desired.

In the illustrated embodiment, the tailpiece 30 is formed from a circumferentially extending wall 31 defining a hollow interior 33 therein. The hollow interior 33 forms an axially extending flow path extending through an entirety of the tailpiece 30. The stem 32 and the receiving portion 34 are each cylindrical in shape with the receiving portion 34 including both a larger outer diameter and a larger inner diameter than the stem 32. The stem 32 and the receiving portion 34 are axially aligned to form a concentric arrangement therebetween. An outer circumferential surface 45 of the stem 32 is arranged parallel to an axial direction of the tailpiece 30 to form an axially extending surface for receiving the first end of the hose 5 thereover. An outer circumferential surface 46 of the receiving portion 34 is similar arranged parallel to the axial direction of the tailpiece 30 to form an axially extending surface for slidably receiving the collar 50 thereover.

A radially outwardly extending bent portion or flange 35 of the wall 31 defines a division between the stem 32 and the receiving portion 34. The bent portion 35 of the wall 31 forms a radially outwardly extending shoulder 36 of the tailpiece 30 having a radial outermost surface positioned radially outwardly of the outer circumferential surface 45 of the stem 32 and the outer circumferential surface 46 of the receiving portion 34. In other words, the shoulder 36 has a larger outer diameter than the stem 32 or the receiving portion 34 of the tailpiece 30. The bent portion 35 of the wall 31, and hence the shoulder 36, may be formed by the cooperation of a first radially outwardly extending portion 37 of the wall 31 extending radially outwardly from an end of the stem 32 and a second radially outwardly extending portion 38 of the wall 31 extending radially outwardly from an end of the receiving portion 34. The manner in which the wall 31 is bent at the bent portion 35 thereof may result in the shoulder 36 having a radiused contour such as a substantially semi-circular contour. The shoulder 36 of the tailpiece 30 is configured for abutting a portion of the collar 50, as explained hereinafter.

The tailpiece 30 may be formed from a metallic material having the requisite characteristics for being deformed into the shapes described herein. The tailpiece 30 may be formed from brass, for example, due to its relative softness and malleability. However, it should be understood that any suitable material may be used as desired in place of the brass without departing from the scope of the present invention.

Although the tailpiece 30 is described as being formed from a cylindrical wall 31 bent into the shape illustrated in FIG. 2, it should be understood that the tailpiece 30 may be formed using any desired manufacturing process resulting in a cross-sectional shape defining each of the stem 32, the receiving portion 34, and the shoulder 36 as shown in FIG. 2 without departing from the scope of the present invention. Specifically, the resulting cross-sectional shape must include the stem 32 having the smallest outer diameter, the receiving portion 34 having a greater outer diameter than the stem 32, and the shoulder 36 having a greater outer diameter than the stem 32 in order for the male coupling 20 to operate in the manner described herein. An outer diameter of the stem 32 may be selected based on an inner diameter of the corresponding hose 5 received over the stem 32. An inner diameter of each of the stem 32 and the receiving portion 34 may be selected based on the desired flow characteristics of a fluid when flowing through the male coupling 20. A thickness of the wall 31 may be selected to be relatively thin in order to minimize the material used in forming the tailpiece 30 while maximizing a flow area through the male coupling 20.

The collar 50 is substantially cylindrical in shape and includes a substantially cylindrical through opening 51 extending axially therethrough from a first end 53 to a second end 54 of the collar 50. The through opening 51 includes a small diameter portion 55 and a large diameter portion 56 aligned axially into a concentric arrangement. The large diameter portion 56 may be formed as a counterbore of the small diameter portion 55, if desired.

The small diameter portion 55 is defined by a first inner surface 61 of the collar 50 extending in the axial direction thereof. The large diameter portion 56 of the collar 50 is defined by a second inner surface 62 of the collar 50 also extending in the axial direction thereof. A radially extending surface 58 joins the first inner surface 61 to the second inner surface 62 at a boundary between the small diameter portion 55 and the large diameter portion 56. The first inner surface 61 and the radially extending surface 58 cooperate to form an inner shoulder 64 of the collar 50.

The small diameter portion 55 includes an inner diameter substantially equal to, but slightly greater than, the outer diameter of the receiving portion 34 of the tailpiece 30. The inner diameter of the small diameter portion 55 is also smaller than the outer diameter of the shoulder 36 of the tailpiece 30. The large diameter portion 56 includes an inner diameter greater than the outer diameter of the shoulder 36 of the tailpiece 30. Based on the preceding relationships, the collar 50 is accordingly received axially over the tailpiece 30 with the receiving portion 34 of the tailpiece 30 passing first through the large diameter portion 56 before entering the small diameter portion 55. The collar 50 is axially received over the tailpiece 30 until the inner shoulder 64 of the collar 50 abuts the shoulder 36 of the tailpiece 30 with the receiving portion 34 of the tailpiece 30 substantially surrounded by the small diameter portion 55 of the through opening 51.

An outer surface of the collar 50 may similarly include a small diameter portion 75 and a large diameter portion 76. The small diameter portion 75 may be generally defined by a first outer surface 81 of the collar 50 extending in the axial direction thereof while the large diameter portion 76 may be generally defined by a second outer surface 82 of the collar 50 also extending in the axial direction thereof. A radially extending surface 83 joins the first outer surface 81 to the second outer surface 82 at a boundary between the small diameter portion 75 and the large diameter portion 76. The radially extending surface 83 and the second outer surface 82 cooperate to form an outer shoulder 86 of the collar 50. The outer shoulder 86 of the collar 50 may be included to form a stopping surface for an end of a corresponding female coupling when securely coupled to the male coupling 20, as desired.

The first outer surface 81 of the collar 50 includes a threaded portion 90. The threaded portion 90 may include male threading configured for mating with the female threading of a corresponding female coupling, as explained hereinabove. The threaded portion 90 may extend axially along the first outer surface 81 beginning at a lip 65 of the collar 50 formed at the open first end 53 of the collar 50. The threaded portion 90 may extend any desired distance along the first outer surface 81 in the axial direction of the collar 50.

The second outer surface 82 of the collar 50 may form a gripping feature 92 of the collar 50. The gripping feature 92 may include each of a tool gripping feature 93 and a hand gripping feature 94 axially spaced from one another with respect to the second outer surface 82. As best shown with renewed reference to FIG. 1, the tool gripping feature 93 may include an octagonal perimeter shape suitable for mating with a tool such as a wrench to facilitate rotation of the collar 50 when attempting to engage/disengage and rotate the collar 50 relative to a corresponding female coupling. The hand gripping feature 94 may include a circumferentially extending knurled surface providing improved friction for similarly facilitating the rotation of the collar 50 during engagement/disengagement with a corresponding female coupling. The gripping feature 92 of the collar 50 may be formed with one or both of the distinct gripping features 93, 94 shown and described herein without departing from the scope of the present invention. Additionally, any suitable structure for gripping the collar 50 may be formed on the second outer surface 82 without necessarily departing from the scope of the present invention so long as the structure does not interfere with the process of threading the threaded portion 90 of the male coupling 20 into a corresponding female coupling.

The collar 50 may be formed from any suitable rigid material, and may be formed from the same material as the tailpiece 30. The collar 50 may be formed from brass, as one non-limiting example.

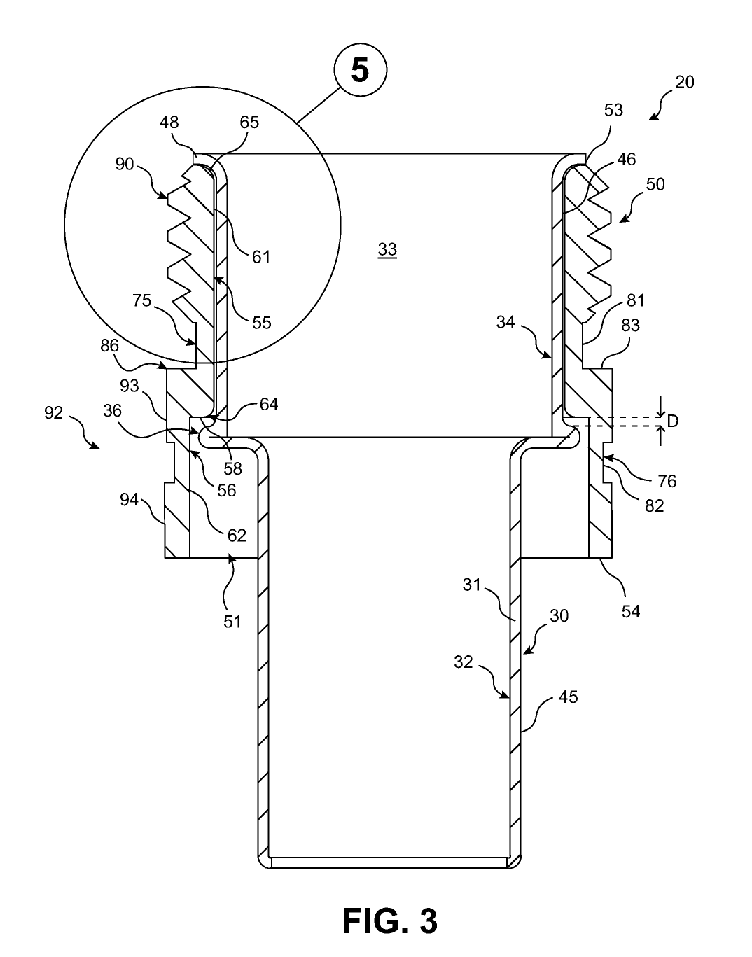

As shown in FIG. 2, an end portion 39 of the receiving portion 34 opposite the shoulder 36 extends axially beyond the lip 65 of the collar 50 following the receipt of the collar 50 over the receiving portion 34 of the tailpiece 30 when the inner shoulder 64 of the collar 50 abuts the first shoulder 36 of the tailpiece 30. As shown by comparison of FIG. 2 to FIG. 3, the end portion 39 of the receiving portion 34 is deformed to flare radially outwardly over the lip 65 of the collar 50 to form an annular rim 48. The lip 65 may be formed to include a substantially arcuate shape as the first inner surface 81 of the collar 50 extends radially outwardly adjacent the first end 51 of the collar 50. The rim 48 may be deformed to include a substantially arcuate shape corresponding to the arcuate shape of the lip 65. The corresponding arcuate shapes better distribute an axial force present therebetween if the collar 50 is pressed axially towards the rim 48.

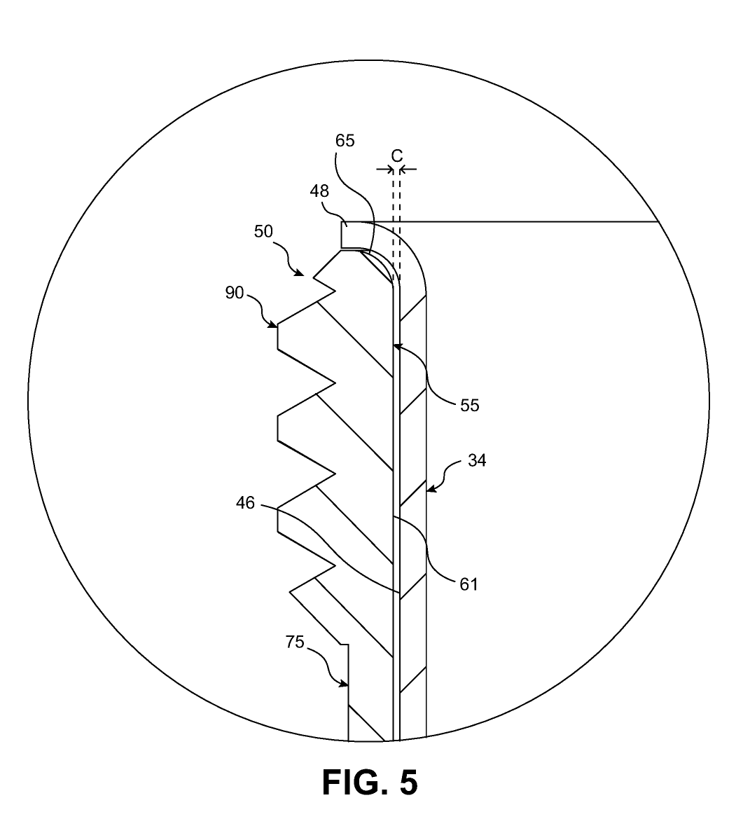

Referring now to FIG. 5, an enlarged view of the outer circumferential surface 46 of the receiving portion 34 relative to the first inner surface 61 of the collar 50 is shown, wherein a clearance C is present therebetween. In certain embodiments, the clearance C may be about 0.006 inches about an entirety of the receiving portion 34, resulting in a difference of about 0.012 inches between the inner diameter of the small diameter portion 55 of the through opening 51 and the outer diameter of the receiving portion 34. The clearance C is provided to allow for the collar 50 to have some play when rotating relative to the receiving portion 34 of the tailpiece 30, thereby preventing seizing of the collar 50 when attempting to rotate the collar 50 relative to the tailpiece 30.

The rim 48 provides a first stopping surface for preventing axial removal of the collar 50 from the tailpiece 30 in a first direction while the shoulder 36 of the tailpiece 30 provides a second stopping surface for preventing removal of the collar 50 over the tailpiece 30 in a second opposing direction. A distance present between the rim 48 and the shoulder 36 of the tailpiece 30 may be greater than a distance present between the lip 65 and the inner shoulder 64 of the collar 50 with respect to the axial direction to form an axial clearance D (FIG. 3). In certain embodiments, the axial clearance D may be at least 0.006 inches, and in other embodiments may be at least 0.020 inches, as non-limiting examples. The axial clearance D allows for the collar 50 to slide at least partially between the rim 48 and the shoulder 36 to better position the collar 50 for engagement with a corresponding female coupling while also preventing potential seizing of the collar 50 relative to the tailpiece 30.

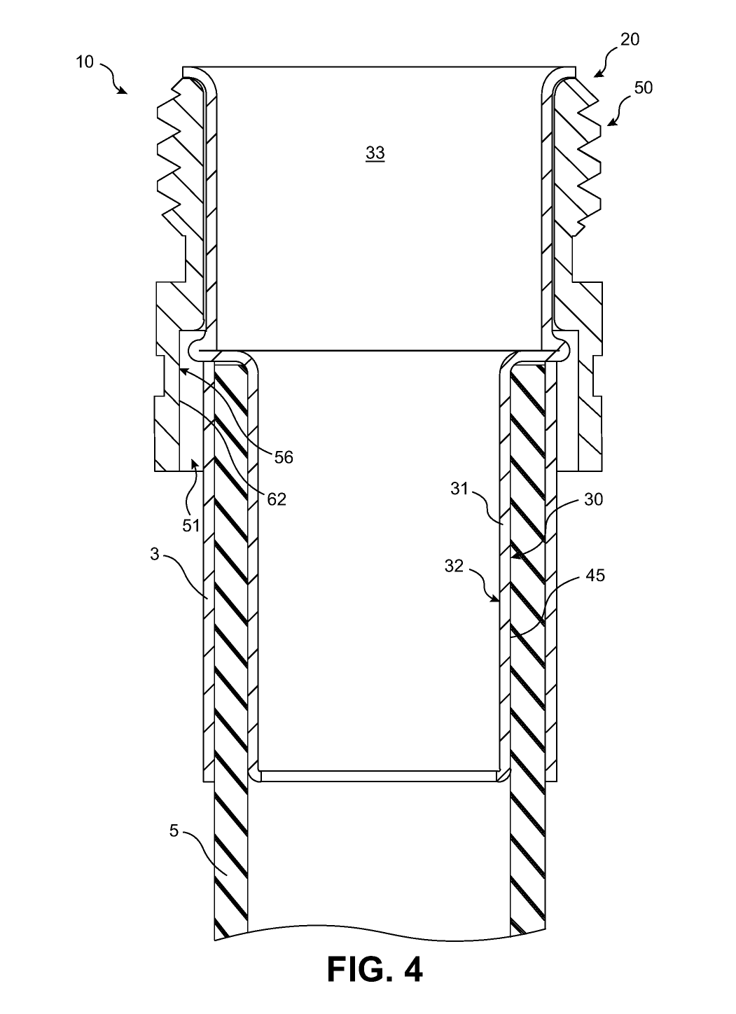

FIG. 4 illustrates a step of coupling the first end of the hose 5 to the male coupling 20 for completing the hose assembly 10. The hose 5 is selected to include an inner diameter substantially corresponding to an outer diameter of the stem 32 and an outer diameter less than the inner diameter of the large diameter portion 55 of the through opening 51. A ferrule 3 formed as a cylindrical member is received over an outer surface of the hose 5 with the ferrule 3 having an inner diameter substantially corresponding to the outer diameter of the hose 5. The ferrule 3 may be formed from the same material as the tailpiece 30, such as brass.

Once the hose 5 is positioned intermediate the ferrule 3 and the stem 32 of the tailpiece 30, both the ferrule 3 and the portion of the wall 31 forming the stem 32 are deformed into an interference pattern for preventing axial movement of the hose 5 relative to the stem 32 or the ferrule 3. The interference pattern may include the ferrule 3 and the wall 31 being formed into a corrugated or serpentine profile such as that shown in FIG. 1 with respect to the outer surface of the ferrule 3. The interior of the hose 5 is thus placed into fluid communication with the hollow interior 33 of the tailpiece 30.

Although the step of coupling the hose 5 to the tailpiece 30 is shown as occurring after the receipt and securing of the collar 50 over the tailpiece 30, it should be understood that the step of coupling the hose 5 to the tailpiece 30 may occur prior to the reception of the collar 50 over the receiving portion 34 due to the direction of reception of the collar 50. The rim 48 may be formed following the reception of the collar 50 over the receiving portion 34 of the tailpiece 30.

In use, the threaded portion 90 of the collar 50 is placed into engagement with the female threading of a corresponding female coupling and the collar 50 is rotated relative to the stationary tailpiece 30 and hose 5 assembly as well as the female coupling. The rotation of the collar 50 relative to the female coupling causes the collar 50 to traverse the female threading to move the male coupling 20 axially towards the female coupling until a distal surface of the female coupling engages the outer shoulder 86 of the collar 50. The hollow interior 33 of the tailpiece 30 is accordingly placed in fluid communication with the interior of the female coupling.

The free rotation of the collar 50 relative to the tailpiece 30 following the coupling of the collar 50 to the corresponding female coupling advantageously results in the ability for the collar 50 and the accessory associated with the female coupling to rotate relative to the hose 5 and the tailpiece 30. For example, if the female coupling is associated with a hand-held nozzle, the user may freely rotate the nozzle relative to the tailpiece 30 and the hose 5 such that the hose 5 is not subjected to a rotation tending to form a kink in the hose 5. The lack of kinks within the hose 5 to prevent an incidence of reduced pressure or flow rate of the fluid flowing through the hose 5. The rotation of the collar 50 also facilitates a coupling of the male coupling 20 to the corresponding female coupling, as the collar 50 may be rotated rather than an entirety of a corresponding accessory or the like associated with the female coupling.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A coupling comprising:
a hollow tailpiece having a receiving portion; and
a hollow collar including a threaded portion, the collar received over the receiving portion and freely rotatable with respect to the receiving portion.

2. The coupling of claim 1, wherein the tailpiece further includes a stem axially aligned with the receiving portion and configured for receipt within a hose.

3. The coupling of claim 2, further comprising a ferrule surrounding the stem and the hose when the stem is received in the hose.

4. The coupling of claim 1, wherein a first end of the receiving portion includes an outwardly extending rim and a second end of the receiving portion includes an outwardly extending shoulder.

5. The coupling of claim 4, wherein the rim is formed by an end portion of the receiving portion deformed radially outwardly.

6. The coupling of claim 4, wherein the shoulder is formed by a bent portion of a cylindrical wall forming the tailpiece.

7. The coupling of claim 4, wherein the collar includes a lip defining an open end thereof and a shoulder spaced from the lip with respect to the axial direction of the collar.

8. The coupling of claim 7, wherein the rim of the receiving portion forms a first stopping surface for engaging the lip of the collar and wherein the shoulder of the receiving portion forms a second stopping surface for engaging the shoulder of the collar.

9. The coupling of claim 7, wherein a distance between the rim and the shoulder of the receiving portion is greater than a distance between the lip and the shoulder of the collar.

10. The coupling of claim 1, wherein a clearance is provided between an axially extending outer surface of the receiving portion and an axially extending inner surface of the collar defining a through opening through the collar.

11. The coupling of claim 1, wherein the threaded portion includes male threading formed on an outer surface of the collar configured for engaging a corresponding female threading.

12. The coupling of claim 1, wherein an outer surface of the collar includes a gripping feature.

13. The coupling of claim 5, wherein the gripping feature is at least one of an octagonal shaped surface or a circumferentially extending knurled surface.

14. A hose assembly comprising:
a hose; and
a coupling, the coupling further comprising:
a hollow tailpiece having a receiving portion and a stem, the stem received in the hose; and
a hollow collar having a threaded portion, the collar received over the receiving portion and freely rotatable with respect to the receiving portion.

15. The hose assembly of claim 14, further comprising a cylindrical ferrule surrounding the hose and the stem.

16. The hose assembly of claim 15, wherein at least one of the ferrule and the stem is deformed for preventing axial movement of the hose relative to the stem.

17. The hose assembly of claim 14, wherein a first end of the receiving portion includes an outwardly extending rim and a second end of the receiving portion includes an outwardly extending shoulder, wherein the collar includes a lip defining an open end thereof and a shoulder spaced from the lip with respect to the axial direction of the collar.

18. The hose assembly of claim 17, wherein the rim of the receiving portion forms a first stopping surface for engaging the lip of the collar and wherein the shoulder of the receiving portion forms a second stopping surface for engaging the shoulder of the collar.

19. The hose assembly of claim 14, wherein the threaded portion of the collar includes male threading formed on an outer surface of the collar.

20. The hose assembly of claim 19, wherein the outer surface of the collar includes a gripping feature spaced apart axially from the male threading.
